(19) United States
(12) Patent Application Publication
(10) Pub. No.: US 2012/0131233 A1
(43) Pub. Date: May 24, 2012

(54) METHOD FOR ASSIGNING DEVICE ADDRESSES TO SENSORS IN A PHYSIOLOGICAL MEASUREMENT SYSTEM, A PHYSIOLOGICAL MEASUREMENT SYSTEM, AND A CONNECTOR ELEMENT FOR A PHYSIOLOGICAL MEASUREMENT SYSTEM

(75) Inventor: Börje Rantala, Helsinki (FI)

(73) Assignee: GENERAL ELECTRIC COMPANY, Schenectady, NY (US)

(21) Appl. No.: 12/951,110

(22) Filed: Nov. 22, 2010

(51) Int. Cl. G06F 3/00

(52) U.S. Cl. 710/12

(57) ABSTRACT

A method for assigning addresses to a plurality of physiological sensor units is disclosed. A physiological measurement system and a connector element for a physiological measurement system are also disclosed. To enable identification of identical sensor units in a measurement system, each input port of a connector element, such as a trunk cable, is adapted to determine at least part of a device address of a sensor unit connected to that input port, thereby to obtain a unique device address for each sensor unit connected to the connector element.

### BACKGROUND OF THE INVENTION

This disclosure relates generally to a physiological measurement system having a plurality of sensors or sensor arrays. More particularly, this disclosure relates to addressing of sensors or sensor arrays in such measurement systems. The term sensor array here refers to a sensor provided with multiple sensing elements, such as electrodes.

Electroencephalography (EEG) is a well-established method for assessing brain activity. When measurement electrodes are attached on the skin of the skull surface, the weak biopotential signals generated in brain cortex may be recorded and analyzed. The EEG has been in wide use for decades in basic research of the neural systems of the brain as well as in the clinical diagnosis of various central nervous system diseases and disorders.

One of the most common EEG electrode placement systems is the standardized 10-20 system, in which at least 21 electrodes are located on the surface of the scalp. However, in clinical environment the EEG measurement electrodes are often placed only onto the forehead of the patient, since a frontal cortex EEG is enough for most clinical applications and the forehead is a convenient measurement area from the point of view of both the patient and the nursing staff. Consequently, various electrode placement systems have been developed for acquiring EEG signals from the frontal and temple areas of a patient.

Traditionally, each electrode is connected to the patient monitor via a dedicated cable, which easily leads to a high number of cables if detailed physiological information is to be obtained from a subject. To reduce the number of cables, sensor arrays may also be used, which may be connected to a patient monitor through a single cable termed trunk cable in this context. A sensor array comprises multiple electrodes provided with a common connector. One sensor array may be used alone or several sensor arrays may be connected to a multi-port connector of the trunk cable to obtain more detailed information from the patient. For example, a sensor array of three electrodes may be used to obtain frontal EEG, while several such triplets may be used for more complex EEG measurements. The use of identical sensor arrays is beneficial from the point of view of sensor manufacturing, and the use of identical sensor arrays further facilitates the assembling of the measurement set-up and decreases the likelihood of improper connections, since the number of connections to be made is lower than in a traditional measurement set-up.

However, the use of a plurality of mutually identical sensor arrays is problematic in terms of sensor identification, since bringing separate address wires from the sensor arrays to the patient monitor is complex and makes the monitor cable thicker. The thicker the monitor cable, the more uncomfortable it is to handle and the more vulnerable it becomes to fractures, for example.

Consequently, it would be desirable to use monitor cables that are as thin and flexible as possible. To this end, a standard serial communication bus would also be preferable, since it contributes to the reduction of the number of conductors and enables use of standard components.

### BRIEF DESCRIPTION OF THE INVENTION

The above-mentioned problems are addressed herein which will be comprehended from the following specification.

A connector element, such as a trunk cable, is provided with one or more input ports for one or more sensor units, respectively. Each input port is adapted to define at least part of a device address of a sensor unit connected to that input port, thereby to obtain a unique device address for each sensor unit connected to the connector element. For this, each sensor unit may be provided with a memory circuit having address inputs based on which the memory circuit is capable of generating a device address. When finishing the connections needed for the measurement set-up, a predefined set of logical (Boolean) values is supplied to the address inputs of each memory circuit. The predefined set is specific to the input port to which the sensor unit is connected, i.e. a unique set of logical values is supplied to the address inputs of each memory circuit when the measurement set-up is completed. Thus, upon connecting identical sensor units to the measurement system, the identical sensor units change into sensor units that may be identified by a patient monitor.

In an embodiment, a method for assigning a device address to at least one physiological sensor unit comprises providing a connector element with at least one input port, wherein each input port is adapted to receive a sensor unit. The method further comprises defining at least one device address respectively for at least one sensor unit, wherein the defining includes adapting each input port to determine at least part of a device address of a sensor unit connected to the input port, wherein the sensor unit is any of the at least one sensor unit.

In another embodiment, a physiological measurement system comprises at least one sensor unit. The system further includes a connector element comprising a first connector interface provided with at least one input port for the at least one sensor unit and a second connector interface adapted to operatively connect the at least one input port to a patient monitor, wherein each of the at least one input port is adapted to determine at least part of a device address of a sensor unit connected to the input port.

In a further embodiment, a connector element for a physiological measurement system comprises a first connector interface comprising at least one input port for sensor unit(s), wherein each input port is adapted to determine at least part of a device address of a sensor unit connected to the input port. The connector element further comprises a second connector interface adapted to operatively connect the at least one input port to a patient monitor.

The mechanism described allows the use of identical sensors or sensor units, which will automatically differentiate when connected to the measurement set-up.

Various other features, objects, and advantages of the invention will be made apparent to those skilled in the art from the following detailed description and accompanying drawings.

### BRIEF DESCRIPTION OF THE DRAWINGS

FIG. 1 illustrates a sensor array according to one embodiment;

FIGS. 2 and 3 illustrate a measurement system in two different embodiments;

FIG. 4 illustrates one embodiment of an interface between multiple sensor arrays and a trunk cable;

FIG. 5 illustrates one embodiment of an address word identifying the sensor arrays of a measurement system; and

FIG. 6 illustrates a trunk cable provided with graphical electrode placement instructions.

### DETAILED DESCRIPTION OF THE INVENTION

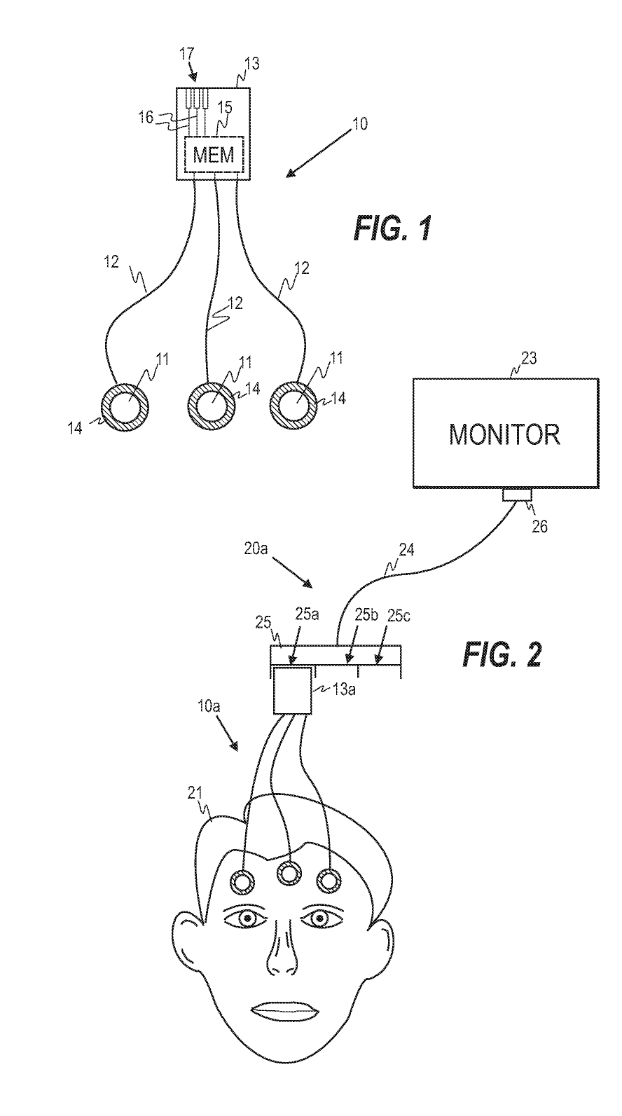

With reference to FIG. 1, a sensor array 10 is shown in accordance with one embodiment. It is assumed here that the sensor array comprises three electrodes 11 for EEG measurement. However, it should be appreciated that the number and type of the electrodes may vary. In the sensor array, each electrode 11 is operatively connected to a conductor 12 that connects biopotential signals from a respective electrode to an array connector 13 common to the electrodes. In the embodiment of FIG. 1, the array connector 13 is a male type connector that may insertably be connected with a female connector of a trunk cable (shown below in FIGS. 2-4). An adhesive material 14 is typically disposed around the periphery of each electrode in order to attach the electrodes to a patient.

A sensor array like this is depicted in U.S. Patent Application US 2008/0221422 A1, where the sensor array is referred to as being a modular sensor array because it defines a standard unit that may be implemented individually or in combination with other generally identically sensor arrays (modularity) and since it comprises multiple sensing elements 11, such as EEG electrodes (array). The sensor array is hereinafter termed sensor triplet, since the sensor array embodiments described here comprise three sensing elements (electrodes) 11.

The array connector 13 comprises a non-volatile memory circuit 15, such as a serial EEPROM circuit, capable of communicating with the patient monitor through a standard communication interface. These types of memory circuits are used in sensors and sensor arrays to store different sensor-specific information, such as sensor type and total usage time. The memory circuit is operatively connected to conductors 12 for receiving biosignals from the electrodes, and also, via conductors 16, to terminals 17 fitted on the surface of the connector 13.

In this embodiment, the housing of the array connector is relatively thin compared to its other dimensions, i.e. the connector has a generally slab-like form. The memory circuit is embedded in the connector housing.

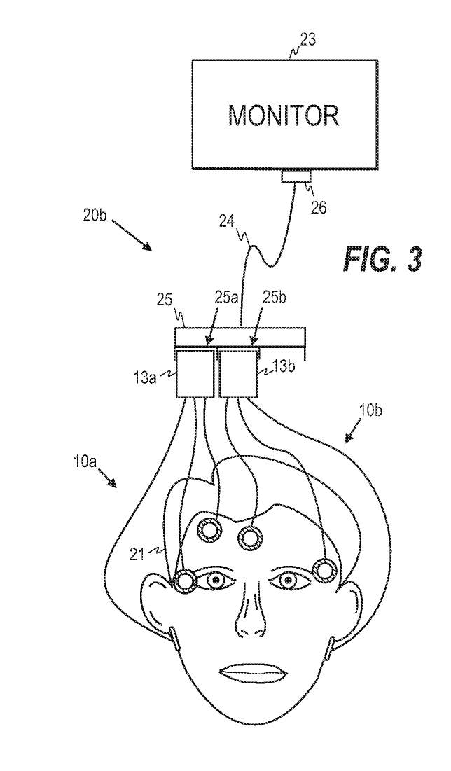

FIGS. 2 and 3 illustrate two embodiments of a sensor measurement system 20, in which one to three identical sensor triplets may be used. In case of FIG. 2, a normal frontal EEG measurement is enough for subject 21, while in case of FIG. 3 the state of the subject has changed and therefore more detailed information is to be obtained. Consequently, in the measurement system 20a of FIG. 2 one sensor triplet 10a is used to measure frontal EEG from the forehead of the subject, while two sensor triplets 10a and 10b are used in a so-called sub-hairline montage to measure EEG signal data from the subject in the measurement system 20b of FIG. 3. It is to be noted that one or more sensor triplets may be used to measure physiological signal data, such as EEG signal data from a subject. The number of sensor triplets may be increased or reduced according to the electrode placement needed in each case.

For connecting the identical sensor triplets to the patient monitor 23, the measurement systems of FIGS. 2 and 3 further comprise a trunk cable 24 provided with a first connector 25 adapted to connect the trunk cable to the sensor triplets and a second connector 26 adapted to connect the trunk cable to the patient monitor. The first connector is in this example provided with three input ports 25a-25c, each input port being adapted to accommodate one sensor triplet.

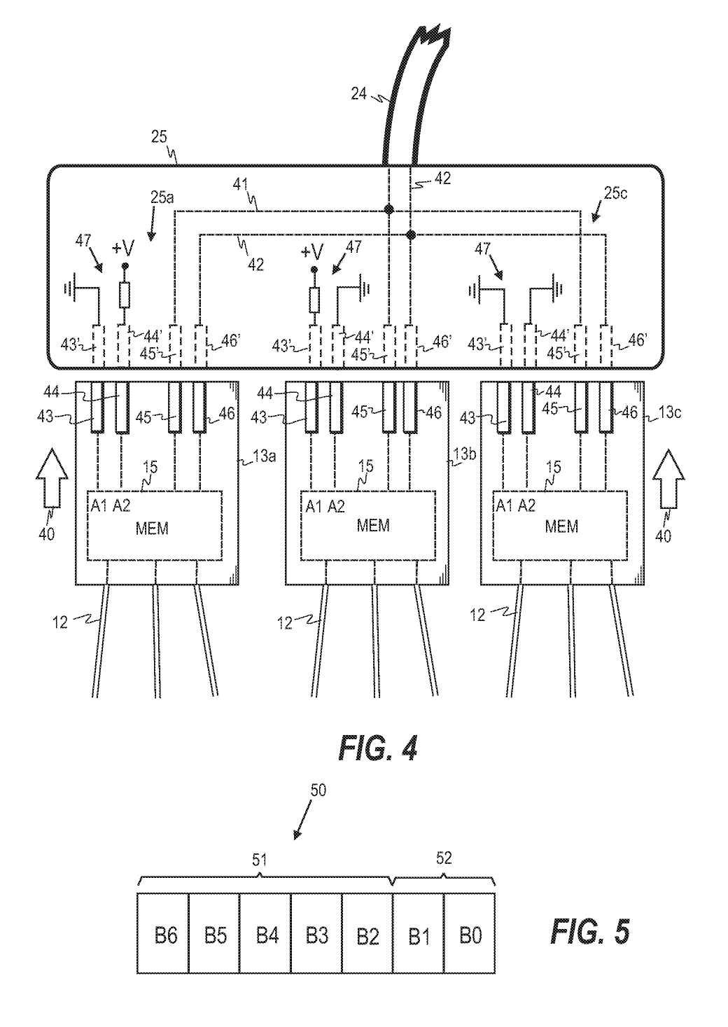

FIG. 4 illustrates one embodiment of assignment of addresses to the sensor triplets in the measurement systems according to FIGS. 2 and 3. The memory circuit 15 comprises multiple address inputs and is capable of forming a device address based on the logical signal values applied to the address inputs. In the example of FIG. 4, two address inputs A1, A2 of the memory circuit are employed. The said inputs are operatively connected to respective address terminals 43, 44 of the connector 13. For each terminal 43-46 fitted to the array connector 13, the input ports 26a-26c of the trunk cable comprise a respective mating terminal denoted with the same reference number provided with an apostrophe.

In each input port of the first connector 25 of the trunk cable, address terminals 43′ and 44′, which mate with the respective address terminals 43 and 44 of the array connectors 13a-13c, are connected in a unique manner to ground and voltage +V. In input port 25a, address terminal 43′ is connected to ground, while address terminal 44′ is connected to voltage +V. In input port 25b, address terminal 43′ is connected to voltage +V, while address terminal 44′ is connected to ground. In input port 25c, both address terminals 43′ and 44′ are connected to ground. Here, +V and ground represent logical one and logical zero, respectively. Consequently, the logical signal value combination supplied to address inputs A1, A2 is different for each sensor triplet, when the array connectors 13a-13c are inserted into the input ports in the direction of arrows 40. As a result, each sensor triplet obtains a unique device address.

As mentioned above, the memory circuit may be, for example, a serial EEPROM circuit, such as an AT24C series circuit. It is assumed here that a standard I²C bus is created between the memory circuit and the patient monitor and that the EEPROM circuit supports the I²C communication protocol. The two communication lines of the I²C bus, serial data line and serial clock line, are denoted with reference numbers 41 and 42 respectively. When the array connectors 13a-13c are inserted into the input ports in the direction of arrows 40, the memory circuits are operatively connected to the serial data line 41 through terminals 45, 45′ and to the serial clock line 42 through terminals 46, 46′.

Only the terminals have been shown, which are relevant in view of the address assignment and data communication. It is to be appreciated that in practical implementations the number of wires/terminals may vary depending on the exact type of the memory circuit and the communication bus. Furthermore, the number of address terminals may vary depending on the number address bits to be defined by the trunk cable. However, normally the logical voltage levels are available from the communication bus and therefore connecting the address terminals to the said voltages is a straightforward task. In an I²C bus, for example, a third line is needed, which is the ground (0 volts) line, and a power line may also be used for the devices (sensor arrays). The address terminals may be hardwired according to the input port position, thereby to connect, in each input port, a port-specific combination of logical voltage levels to the address terminals. In addition to conductors, the switching elements 47 that carry out the necessary connections to the logical voltage levels may include resistors, for example, as is illustrated in FIG. 4. It is also to be noted that the logical voltage levels are supplied to the address terminals of each memory circuit only when all the necessary connections have been made, i.e. when a power source is connected to the measurement set-up.

As discussed above, the memory circuit is capable of producing a device address that depends on the logical signal values connected to the address inputs thereof. The address bits defined by an input port may define part of the address word. In an I²C bus, for example, the device address comprises typically 7 bits. For example, the N least significant bits of the address word may be defined by the trunk cable, while the remaining address bits, the 7-N most significant address bits, may include a fixed bit sequence that is the same for all sensor arrays. This stem of the address word may be stored in the manufacturing stage of the sensor array. For example, the stem of the address word may comprise 5 bits and the remaining two address bits may define whether the sensor array is in the right, middle, or left input port of the trunk cable. FIG. 5 illustrates a 7-bit address word 50 consisting of bits B6-B0. Here, address bits B6-B2 form the fixed address stem 51, while bits B1 and B0 form the non-fixed address part 52 defined by the trunk cable. The number and positions of the address bits defined by the trunk cable may vary and the trunk cable may also define the entire address word.

Since the master node of the bus, i.e. a controller in the patient monitor, knows the address related to each input port, it may start communicating with the sensors array(s) immediately when one or more sensor arrays have been connected to the trunk cable for a measurement.

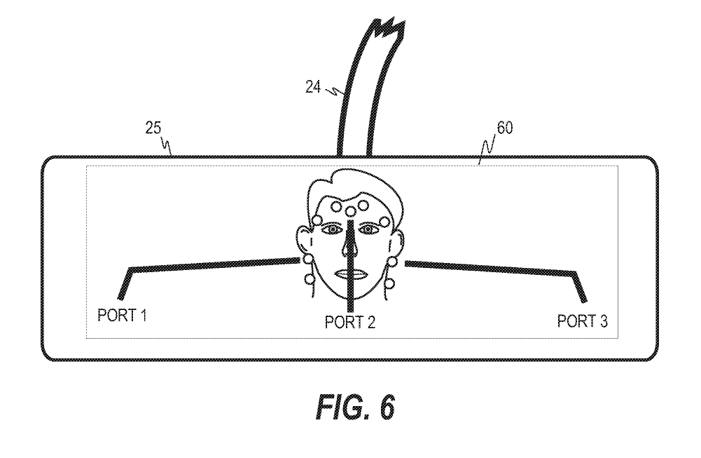

In a further embodiment, the top surface area of the first connector 25 may be utilized by providing the connector with information about electrode placement. FIG. 6 illustrates an example in which a sticker 60 is attached onto the top surface of the first connector 25 of the trunk cable 24. The sticker may indicate the electrode placements related to each input port. In this embodiment, the patient monitor is thus able to associate a certain triplet address with the physiological measurement site/area.

In one embodiment, if sensor arrays of different types are used, the stem of the address word may be fixed within sensor arrays of the same type, but may be different for sensor arrays of different types.

In the above embodiments, multiple input ports are used in the trunk cable for the sensor arrays. However, for measurements that do not require more than one sensor array, the trunk cable may also be provided with a single input port only. Further, the memory circuit may be provided with only one address input or only one address input may be employed in the above-described manner. It is to be appreciated that in this case the port-specific set/combination of logical address input values comprises only one logical value. The above address assignment functionality may also be adapted to a separate connector that comprises multiple input ports for the sensor arrays and provides a further interface for operatively connecting the sensor arrays to a patient monitor. That is, connector 25 and trunk cable 24 may be separate elements. The voltage levels corresponding to the logical values may vary depending on the type of memory circuit used. Furthermore, the address assignment mechanism described above may also be applied to sensors comprising only one sensing element. The term sensor unit is used in the attached claims to refer to all embodiments in this regard.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural or operational elements that do not differ from the literal language of the claims, or if they have structural or operational elements with insubstantial differences from the literal language of the claims.

1. A method for assigning a device address to at least one physiological sensor unit, the method comprising:
providing a sensor unit having a memory circuit with a memory input, the memory circuit capable of producing a device address based on the memory input;
providing a connector element with at least one input port, wherein the input port is adapted to receive the sensor unit and to connect to the memory input of the memory circuit in the sensor unit; and
defining a device address for the sensor unit,
wherein the defining includes combining an address element internal to the memory circuit with an address element received by the memory input from the input port.

2. The method according to claim 1,
wherein the input port has switching elements adapted to transmit a port-specific address input values to the memory input when the sensor unit is connected to the input port, thereby to allow the memory circuit of the sensor unit to produce a port-specific device address for the sensor unit.

3. The method according to claim 2, wherein elements of the input port comprise hardwired conductors.

4. The method according to claim 2, further comprising providing the connector element with graphical information about electrode placement.

5. The method according to claim 2, wherein the memory circuit provides a standard communication interface towards the connector element.

6. The method according to claim 5, further comprising providing a serial bus through the connector element, wherein the serial bus is common to the at least one sensor unit and forms the standard communication interface.

7. A physiological measurement system comprising:
at least one sensor unit having a memory circuit with a memory input, the memory circuit capable of producing a device address based on the memory input; and
a connector element comprising a first connector interface provided with at least one input port capable of receiving the sensor unit and a second connector interface adapted to operatively connect the input port to a patient monitor,
wherein the input port is adapted to connect to the memory input of the memory circuit in the sensor unit in order to determine at least part of the device address of the sensor unit.

8. The physiological measurement system according to claim 7, wherein
the input port is provided with a switching elements adapted to connect to the memory input of the memory circuit and provide a port-specific address input values to the memory input when the sensor unit is connected to the input port, thereby to allow the memory circuit of the sensor unit to produce a port-specific device address for the sensor unit.

9. The physiological measurement system according to claim 8, wherein the switching elements comprises hardwired conductors.

10. The physiological measurement system according to claim 7, wherein the connector element is provided with graphical information correlating electrode placement to the input port.

11. The physiological measurement system according to claim 7, wherein the at least one sensor unit comprises a plurality of identical sensor units.

12. The physiological measurement system according to claim 8, wherein the memory circuit provides a standard communication interface towards the connector element.

13. The physiological measurement system according to claim 12, wherein the standard communication interface comprises a serial bus common to the at least one sensor unit.

14. A connector element for a physiological measurement system, the connector element comprising:
a first connector interface comprising at least one input port for receiving a sensor unit having a memory circuit with a memory input,
wherein the memory circuit is capable of producing a device address based on the memory input, and
wherein each input port is adapted to connect to the memory input to determine at least part of the device address provided by the memory circuit of the sensor unit; and
a second connector interface adapted to operatively connect the input port to a patient monitor.

15. The connector element according to claim 14, wherein the input port is provided with a switching elements adapted to connect to the memory input to transmit a port-specific address input values to the memory circuit in the sensor unit.

16. The connector element according to claim 15, wherein the switching elements comprises a hardwired conductors.

17. The connector element according to claim 14, wherein the connector element is provided with graphical information correlating electrode placement to the input port.

18. The connector element according to claim 14, wherein the second connector interface provides a standard communication interface.

19. The connector element according to claim 18, wherein the standard communication interface comprises a serial bus.

20. The connector element according to claim 14, wherein the connector element is a trunk cable.
